(19) United States
(12) Patent Application Publication
(10) Pub. No.: US 2008/0283002 A1
(43) Pub. Date: Nov. 20, 2008

(54) Multi-Cylinder Two-Stroke Radial Engine

(75) Inventors: Ioannis Mantheakis, Attiki (GR); Antonios Voulgarelis, Attiki (GR)

Correspondence Address: NIXON & VANDERHYE, PC, 901 NORTH GLEBE ROAD, 11TH FLOOR, ARLINGTON, VA, 22203, US

(73) Assignee: KYOSHO CORPORATION, Tokyo (JP)

(21) Appl. No.: 11/658,554

(22) PCT Filed: Apr. 4, 2006
(86) PCT No.: PCT/GR06/00017

§ 371 Date: Apr. 9, 2007

(30) Foreign Application Priority Data
Apr. 4, 2005 (GR) 20050100170

(51) Int. Cl. F02B 75/22

(52) U.S. Cl. 123/54.2

(57) ABSTRACT

Multi-cylinder two-stroke radial engine, specially intended for use in models with a cubature in the order of 0.30-1.20 in³ and particularly for model aircraft applications. It comprises (FIG. 1) a cylindrical body (1) on the perimeter of which there are radially positioned cylinders (2) inside which travel pistons (2a) connected by means of connecting rods (6) to a configuration of an equal number of crankshafts (8a) that pass through the cylindrical body (1) and their gear wheels (8b) engage with a gear wheel (3a) of the central axis (3) in the interior of the body (1), which comprises the crankcase of the engine and is structured in such a way that the desired compression is achieved. A feature of the invention is the even distribution and simultaneous ignition of the combustible mixture in all cylinders by means of an even distribution arrangement, which according to one application of the invention, comprises a reed valve (40) which reciprocates for the two strokes of operation between the fuel intake channel 13a on the backplate of the engine and the reed retainer (41) that fits to the latter

This invention concerns a two-stroke, multi-cylinder internal combustion engine with the cylinders arranged in a radial configuration; its configuration, inter alia, renders the two-stroke engine suitable for use in scale models (model aircraft).

In the field of scale-model engines, as for example in the field of model aircraft, a variety of internal combustion engines of different types and cylinder configurations are known. Two-stroke engines are used, as well as four-stroke. Using two-stroke engines is popular practice among model hobbyists, for its simpler structure, lighter weight and better performance as compared to the four-stroke engine which is significantly heavier, with more components requiring costly maintenance and no resemblance whatsoever to the appearance and style of the engines used in the era represented by the model; nevertheless, to this day two-stroke engines in multi-cylinder configurations have not shown satisfactory performance. The key problem hindering successful utilization of the two-stroke multi-cylinder engine relates to achieving the necessary compression in the crankcase.

The object of this invention is thus to mitigate the drawbacks of the existing technology by means of a combination of crankcase and mixture intake arrangement that would ensure an even distribution of the combustible mixture as well as simultaneous and uniform ignition in all the cylinders of the engine.

A second object of this invention is the implementation of cylinders and pistons in a radial configuration in order to successfully simulate early-era engines, in versions with different numbers of cylinders (four, five, six etc.) and different sizes (cubic centimeters) starting from exceptionally small volume, and aiming particularly at scale-model engines especially in the order of 0.30-1.20 in³.

The invention can be comprehended by those familiar with such technologies, with reference to the accompanying drawings, in which:

Drawing 1 presents a first application of the proposed multi-cylinder two-stroke engine in an exploded view; mixture intake is controlled by means of a reed valve.

Drawing 2 presents an alternative application of the proposed multi-cylinder two-stroke engine in an exploded view; mixture intake is controlled by means of a cylinder fitted to the extension of the central axis of the engine.

Drawing 3 presents the reed valve components employed in the application of Drawing 1 with a suitably designed backplate for the engine and a fitting reed retainer.

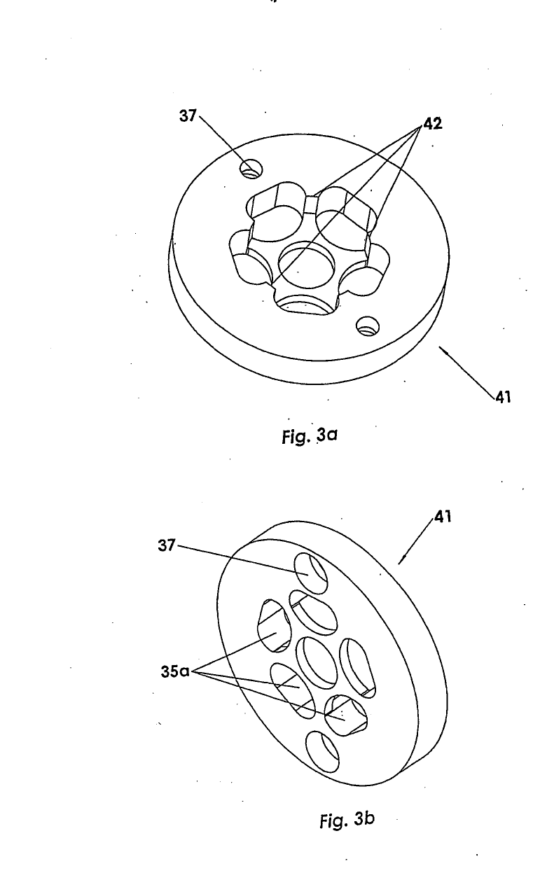

FIGS. 3a and 3b show a perspective view of the two sides of the reed retainer used in the reed valve configuration.

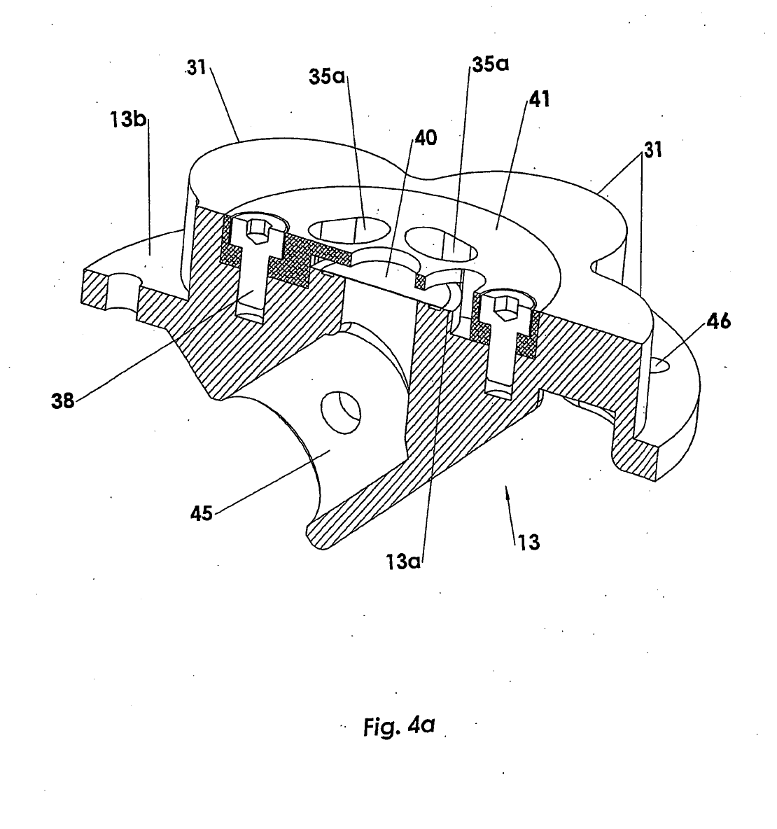

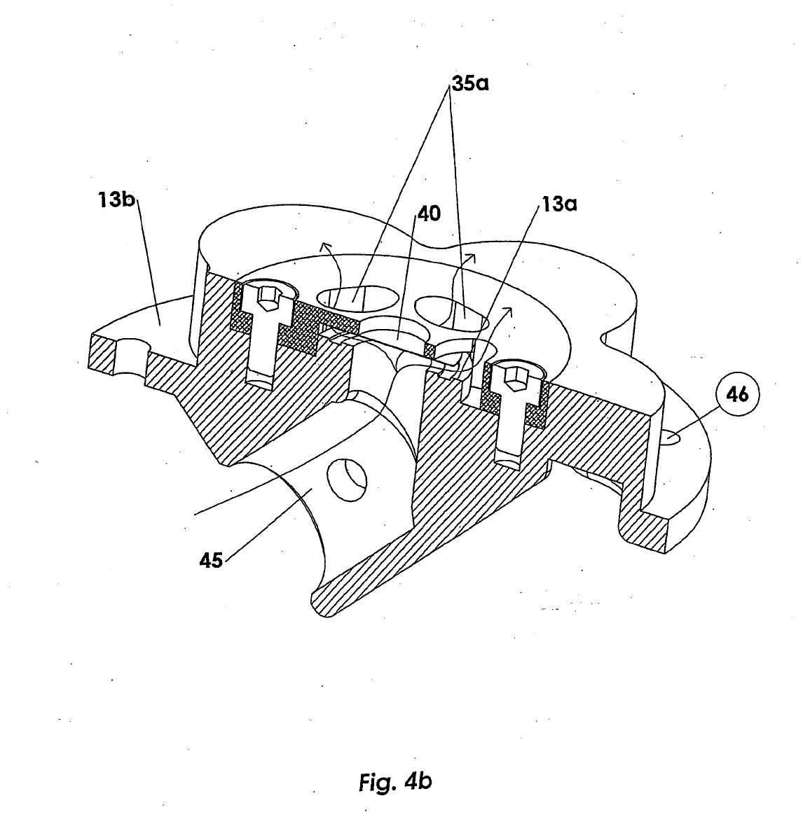

FIGS. 4a and 4b show a perspective section view of the reed intake configuration in open and closed position respectively.

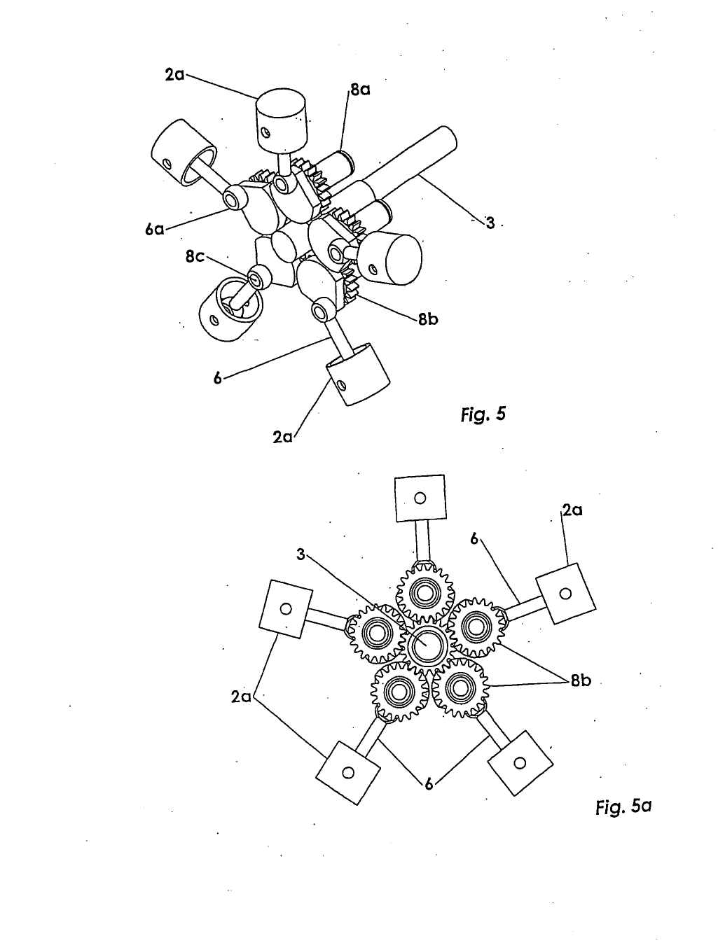

FIGS. 5a and 5b show a perspective and plan view of the crankshafts connected to the central axis and the radial connecting rods and pistons.

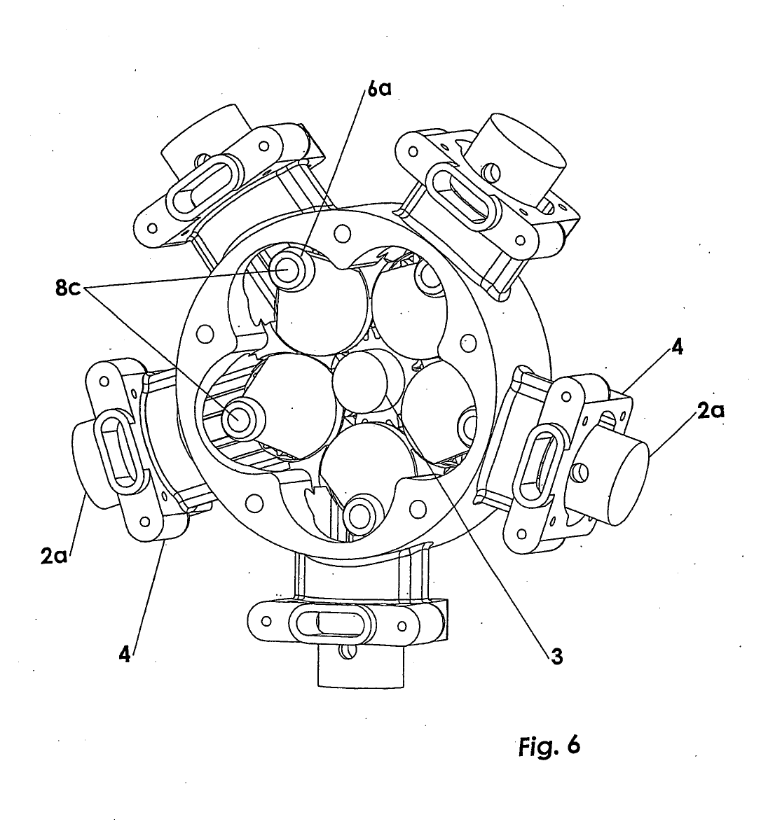

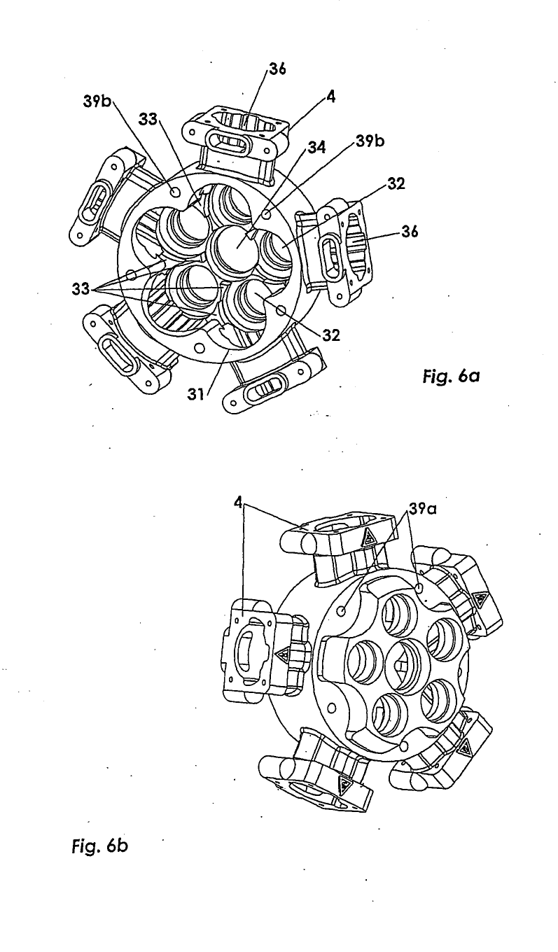

FIGS. 6 and 6a show a perspective detail view of the inside of the engine body with and without the crankshaft arrangement and connected pistons respectively.

FIG. 6b shows a perspective detail view of the inside of the engine body with the crankshaft arrangement as seen from the front view of the engine body.

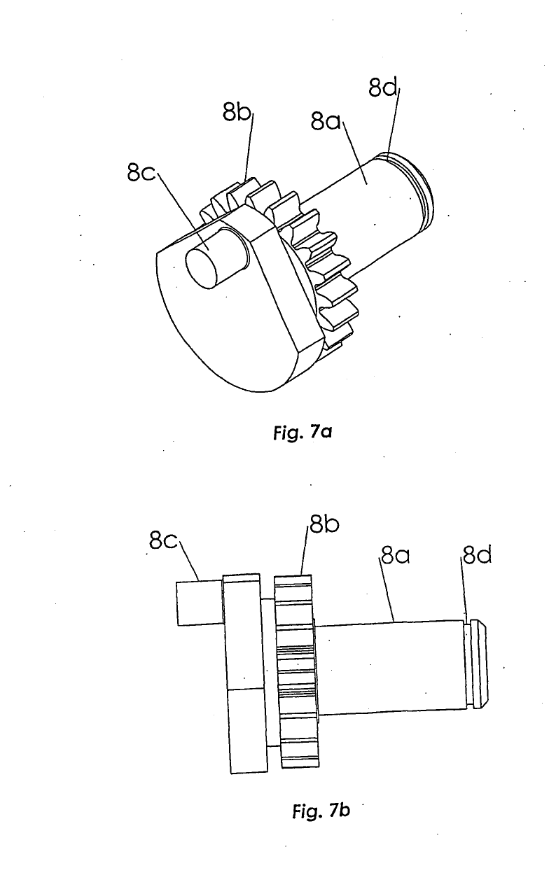

FIGS. 7a and 7b respectively show a perspective and section view of a typical crankshaft used in the invention, integrated with the transmission gear wheel.

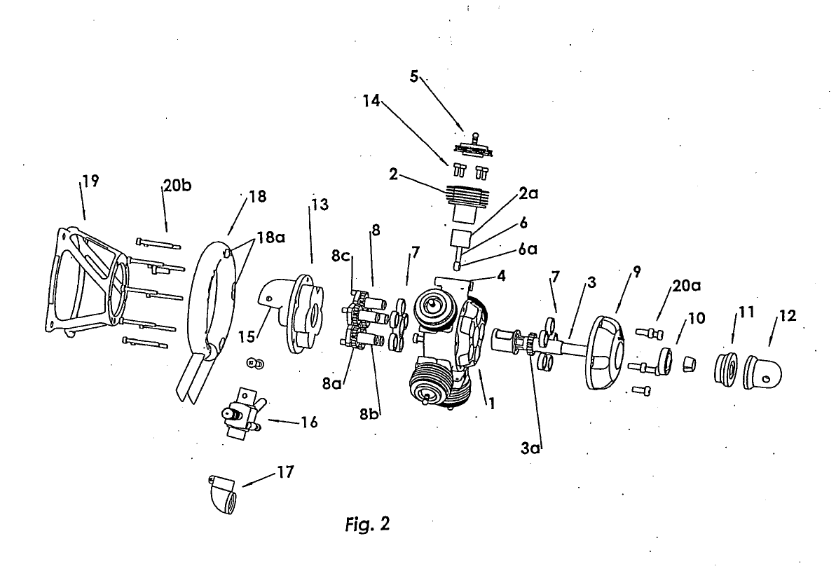

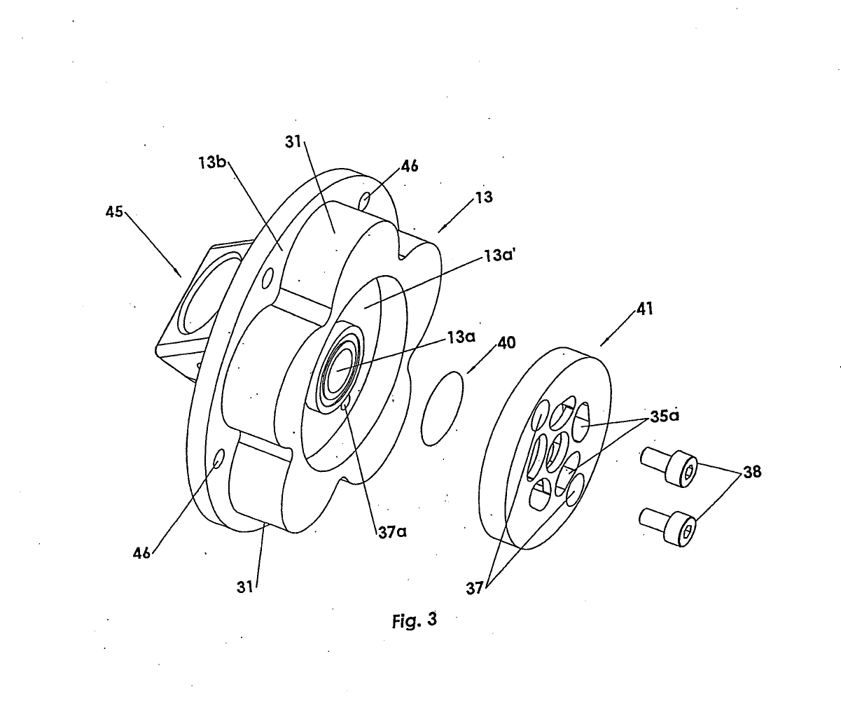

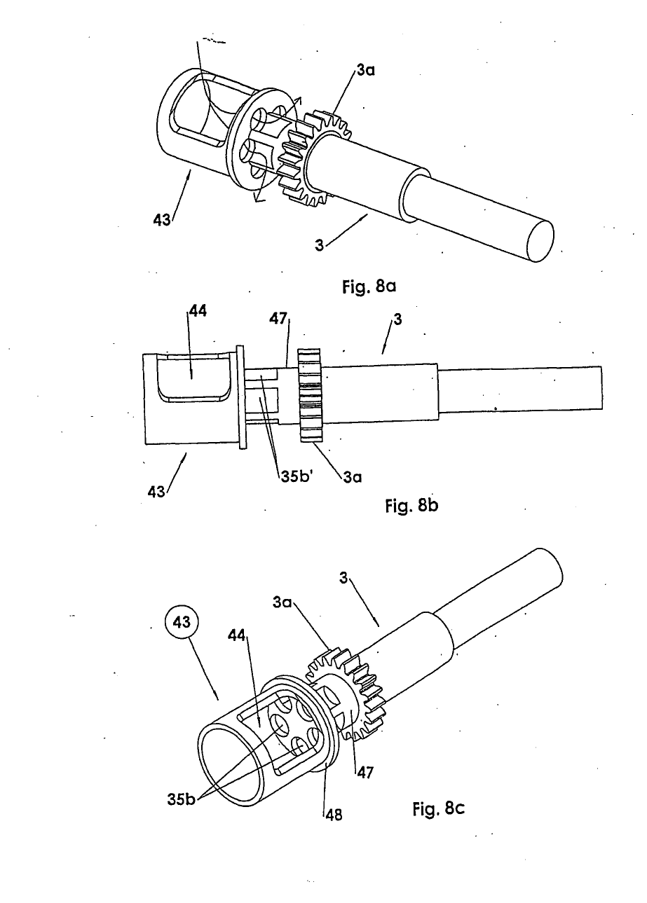

FIGS. 8a, 8b and 8c show various perspective views of the central axis of the engine with the integrated fuel distribution chamber according to the alternative application of FIG. 2.

The multi-cylinder two-stroke radial engine indicatively presented in the drawings features a radial configuration of the cylinders 2 on the perimeter of the cylindrical body 1, which bears suitably formed sockets in radial symmetry for fitting of the cylinders and their accessories.

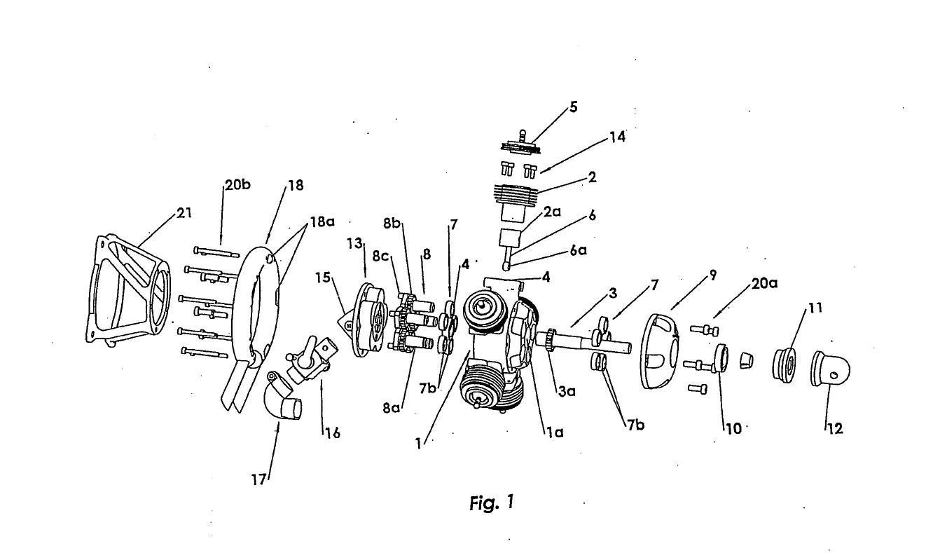

The multi-cylinder two-stroke radial engine, as depicted especially for model airplane applications in FIG. 1 or 2, comprises the cylindrical main body 1 with an indicative five cylinders 2, which are supported on radial blocks 4 on the body 1 with holes 36 for supply of the fuel/air mixture to the cylinders 2. The cylinders 2 are arranged on a plane vertical to the central propeller axis 3 of the engine; the number of cylinders can be altered, so long as the radial symmetry arrangement is maintained. For each cylinder 2 there is an igniter 5 which is connected to the cylinder 2 by means of screws 14 and a connecting rod that connects to the piston 2a reciprocating within the cylinder 2. The blocks 4 on the body 1 can be of a square or other shape, depending on the employed cylinders 2. On either side of the body 1 there are special grooves to accommodate roller bearings 7 through which the crankshafts 8a rotate, while each crankshaft is connected to the base 6a of a respective connecting rod 6 that corresponds to a cylinder 2.

The central propeller axis 3 bears a gear wheel 3a, which is inserted into the inside of the cylindrical body 1 where it engages with the planetary gear wheels 8b of the crankshafts 8a. The body 1 is covered with a front (in the direction of propulsion of the aircraft when the engine is employed in model aircraft applications) cover 9 with a roller bearing socket 10 and a backplate 13 by which a mixture intake arrangement is connected to the crankcase, i.e. in the interior of the cylindrical body 1 where the planetary gear wheels 8b of the crankshafts 8a are connected to the gear wheel 3a of the central propeller axis 3. On the external surface of the backplate 13 there is also connected a mixture intake arrangement including a carburetor 16 combined with an air intake funnel 17 and a ring-shaped silencer exhaust 18. The front cover 9, which bears a suitable socket for the roller bearing 10 of the central propeller axis 3, the hub 11 and the cover 12 of the propeller is connected to the front of the body 1 by means of an arrangement of screws 20a that travel through a perimeter arrangement of holes on the cover 9 and enter matching holes 39a on the perimeter of the body 1. On the other side, the backplate 13 is connected to the body 1 by means of an arrangement of screws 20b that travel through a perimeter arrangement of holes 18a on the exhaust pipe 18, a perimeter arrangement of holes 46 on the backplate 13 and enter matching holes 39b on the perimeter of the body 1. The entire assembled engine is, for model aircraft applications, fixed to the fuselage of the aircraft by aid of a mounting base 19.

The backplate 13 has a channel formation 13a for the passage of the fuel/air mixture and along the perimeter of opening 13a an arrangement of consecutive planetary identical circular formations 31 equal in number to the number of cylinders 2 and crankshafts 8a of the engine. It is characteristic that the perimeter arrangement of consecutive planetary identical circular formations 31 around the opening 13a forms the shape of a daisy. The cylindrical body 1 respectively bears a socket to accommodate the backplate 13 with consecutive planetary identical circular formations 31′ forming a perimeter respective to the daisy configuration of the backplate 13 and formed in its interior is the engine crankshaft, which includes an arrangement of structured channels: on the one hand a central channel 34 for the passage of the central axis 3 and on the other consecutive planetary identical channels 32 for the passage of the corresponding crankshafts 8a. The interstices between the central channel 34 for passage of the central axis 3 and the consecutive planetary identical channels 32 for the passage of the corresponding crankshafts 8a are built of solid walling 33, so that the desired controllable compression is achieved within the crankcase.

After insertion of the crankshafts 8a in the consecutive planetary identical channels 32, crossing of the central channel 34 and engaging of the gear wheels 8b of the crankshafts 8a on the perimeter of gear wheel 3a of central axis 3 and connection of the backplate to the body 1, the aforementioned central channel 13a for passage of the mixture lies at the extension of the central channel 34 for the passage of central axis 3.

Functioning within the central channel 13a is a time-controlled arrangement for the intake and distribution of the mixture, which includes a planetary arrangement of a number of holes 35a or 35b equal to the number of identical cylinders 2 by means of which the mixture is fed to the cylinders 2 by means of the identical holes 36 on the blocks 4 around the perimeter of the cylindrical body 1.

According to an initial preferred application of the invention, as depicted in FIGS. 1, 3, 3a, 3b, 4a and 4b, the mixture is fed to the central channel 13a by means of a hole in the bottom of the central channel 13a and the aforementioned time-controlled arrangement for the intake and even distribution of the mixture to the cylinders 2 includes a reed valve 40 (FIG. 3) of such a size and shape that it seals the central channel 13a. The said fitting around the central channel 13a forms a shallow cavity 13a′ to which a circular reed retainer is fitted. The perimeter of the retainer 41 bears the holes 35a for even distribution of the mixture to the cylinders 2. On the side where it fits to the backplate 13, the retainer 41 includes a shallow cavity with an arrangement of an equal number of ribs 42 corresponding to the holes 35a, which ribs are tangent to the perimeter of the reed valve 40 and enable it to reciprocate between the closed position (Drawing 4a) at which the valve is tangent to and seals the central channel 13a and the open position, (FIG. 4b) at which the reed valve 40 is shifted in the direction of the retainer 41, and the mixture exiting the central channel 13a is fed laterally of the reed valve 40 by means of the interstices between the ribs 42 to exit via the holes 35a, evenly distributed to the cylinders 2. The proposed herein reed valve has a plain circular shape and is resilient, as its geometry shows no points susceptible to the manifestation of material failure and displays minimal inertia.

According to a second application of the invention, as depicted in FIGS. 2, 8a, 8b and 8c, the mixture is fed to the central channel 13a by means of a hole on the perimeter of the central channel 13a. In this case the time-controlled arrangement for the intake and even distribution of the mixture to the cylinders 2 comprises a [fitted to an extension of the central axis 3] cylindrical chamber 43 with a port 44 of a specified arc length of its perimeter, a pedestal 48 of a slightly augmented diameter and perforated with an arrangement of holes 35b for even distribution of the mixture by means of an equal number of identical ports 35b′, which are situated on a cylinder 47 subject to the pedestal 45, on the radially positioned cylinders 2 of the engine. The cylindrical chamber fits within the central channel 13a, which it seals with the aforementioned pedestal 45, and inflow of the mixture to the cylindrical chamber 43 and subsequent even distribution via holes 35b and ports 35b′ to the cylinders 2 is performed when, during rotation of the central axis 3, the port opening 44 of the cylindrical chamber 43 coincides with the hole situated on the perimeter of the central channel 13a.

A general characteristic feature of the invention is that each of the crankshafts 8a shown in detail in FIGS. 7a and 7b is jointly manufactured of one single piece of metal as gear wheel 8b engaging with gear wheel 3a of the central axis 3 and the eccentric surface with pin 8c overlying the gear wheel 8b by means of which the crankshaft 8a is connected to the end ring 6a of the respective connecting rod 6. At the terminal end of each of the crankshafts 8a there is a slit 8d within which it is locked with a safety lock after passing through the cylindrical body 1 (FIG. 6b).

The operating cycle of the engine of the invention comprises the movement of pistons 2a from the bottom dead center (BDC) to the top dead center (TDC), where negative pressure is created in the integrated crankcase chamber which is enclosed by the body 1 and the backplate 13 of the engine. In the case of the application with the valve 40 as in FIG. 1, the negative pressure shifts the reed valve 40 so that it frees the entrance of the chamber and lets the mixture in (FIG. 4b), while in the case of the application with the chamber 43 for distribution of the fuel as an extension of central axis 3, by rotation of axis 3 the chamber 43 comes to a position where port 44 coincides with the lateral port of the fuel intake channel 13a and the fuel is introduced. By movement of the pistons 2a, the mixture is fed to the top part of the cylinders where it is ignited by the igniters 5 and the produced expansion pushes the pistons in the opposite direction from the TDC to the BDC. During travel the pistons 2a drag along the connecting rods 6 which in turn rotate the crankshafts 8a and as the gear wheels 8b of the crankshafts 8a engage with the gear wheel 3a of the central propeller axis 3, the latter is rotated in the opposite direction.

The entire cycle described above is repeated continuously and simultaneously by all the cylinders 2 of the engine.

The engine of the invention described above is exceptionally compact Owing to its operating mode (two-stroke), it has much fewer components and moving parts (in comparison to the four-stroke engine of respective performance) and thus presents minimal to zero wear. Thus its needs in maintenance are substantially reduced, the direct result of which is economical use. When compared to a two-stroke single-cylinder of respective size, it is again superior because the maximum radial distance from the axis to the external perimeter is the smallest possible, and thus smaller than that of the respective single-cylinder engine.

Because of the radial configuration of the cylinders and the simultaneous and uniform ignition of the combustible mixture, the engine displays minimal vibration. This results from the creation of radially arranged forces, with a common center (that of the propeller axis). The thrusts induced by these forces eliminate one another and result in a next-to-zero resultant, as all forces act on the same plane. Moreover, the symmetrical design of the engine lends it the capacity of operating both clockwise and counter-clockwise.

The multi-cylinder two-stroke engine is characterized by the fact that its external appearance resembles that of early-era engines, offering a considerable aesthetic advantage to model hobbyist users.

It should however be noted that the description was made with mention to indicative examples without being restricted only to such. Thus any alteration that does not comprise an inventive step is considered to be included in the objects and intentions of this invention as set forth in the claims given below.

1. Multi-cylinder two-stroke radial internal combustion engine comprising a cylindrical body (1) on the perimeter of which there are radially positioned blocks (4) accommodating a number of identical cylinders (2), each cylinder (2) equipped with an igniter (5) and a connecting rod (6) with piston (2a), a crankshaft configuration (8) with a number of crankshafts (8a) equal to the cylinders (2), each crankshaft (8a) connected respectively to a connecting rod (6) of a piston (2a), through which the crankshafts (8a) pass vertically by means of the said cylindrical body (1) supported on roller bearing arrangements (7) that are fitted on either side of the said body (1), a central axis (3) passing through a central hole (7a) of the roller bearing arrangements (7) and a central hole (Ia) of the body (1), and inside the body (1) a gear wheel (3a) of the central axis (3) engages with planetary gear wheels (8b) of the crankshafts (8a), a front cover (9) with a roller bearing socket (10) for the central axis (3) and a backplate (13), an arrangement for the intake of combustible mixture to the engine, where the combustible mixture comes from a carburetor (16) combined with an air intake funnel (17) and a ring-shaped silencer exhaust (18) fitted externally to the backplate (13), characterized by the fact that:
the said backplate (13) is formed with a central channel (13a) for the passage of the combustible mixture and around the perimeter of the opening (13a) an arrangement of consecutive planetary identical circular formations (31) equal in number to the number of cylinders (2) and crankshafts (8a) of the engine, where the said arrangement of consecutive planetary identical circular formations (31) around the perimeter of the opening (13a) forms the shape of a daisy,
the said cylindrical body (1) bears a socket to accommodate the said backplate (13) with a perimeter respective to the daisy configuration of the said backplate (13) comprising consecutive identical circular formations (3T) and an arrangement of structured channels, on the one hand a central channel (34) for passage of the central axis (3) and on the other consecutive planetary identical channels (32) to accommodate the corresponding crankshafts (8a) and walling (33) for structuring the interstices between the said central channel (34) for passage of the central axis (3) and the consecutive planetary identical channels (32) accommodating the equal number of crankshafts (8a), so that, after insertion of the crankshafts (8a) through the consecutive planetary identical channels (32), the passage of the central axis (3) through the central channel (34), the engaging of the gear wheels (8b) of the crankshafts (8a) on the perimeter of the gear wheel (3a) of the central axis (3) and connection of the said backplate (13) to the body (1), the said central channel (13a) for passage of the combustible mixture is situated at the extension of the central channel of the central axis (3), where inside the central channel (13a) functions a time-controlled mixture intake and distribution arrangement which comprises a planetary arrangement of an equal number to the said identical cylinders (2) of holes (35a) or (35b) for the even distribution of the combustible mixture that is fed to the cylinders (2) by means of identical holes (36) distributed on the perimeter of the cylindrical body.

2. A multi-cylinder two-stroke radial internal combustion engine according to claim 1 above, characterized by the fact that the combustible mixture is fed into the said central channel by means of a hole in the bottom of the central channel (13a) and that the said time-controlled arrangement for intake and even distribution of the mixture to the cylinders (2) comprises a reed valve (40) of such a shape and size that it seals the said central channel (13a), where around the said central channel (13a) there is a shallow cavity (13a′) which accommodates a circular reed retainer (41) on the perimeter of which are the said holes (35a) for even distribution of the mixture to the cylinders (2), where on the side fitting with the said backplate (13), the reed retainer (41) includes a shallow cavity with an arrangement of an equal number of respective to the holes (35a) ribs (42) that are tangent to the perimeter of the said reed valve (40) and allow reciprocation of the said reed valve (40) between the closed position at which it is tangent to and seals the said central channel (13a) and the open position where the said reed valve (40) is shifted in the direction of the said reed retainer (41) so that the combustible mixture exiting the said central channel (13a) is channeled laterally of the reed valve (40) by means of the intervening interstices between the said ribs (42) to exit by means of the holes (35a) evenly distributed to the said cylinders (2).

3. A multi-cylinder two-stroke radial internal combustion engine according to claim 1 above, characterized by the fact that the combustible mixture is fed to the said central channel (13a) by means of a hole on the perimeter of the central channel (13a) and by the fact that the said arrangement for time-controlled intake and even distribution of the mixture in the cylinders (2) comprises a cylindrical chamber (43) with a port opening (44) of a specific arc length of the perimeter, a pedestal (48) of a slightly greater diameter and perforated with an arrangement of the said holes (35b) for even distribution of the mixture by means of an equal number of identical ports (35b′) on the underlying to the said pedestal (48) cylinder (47) on the radially positioned cylinders (2) of the engine, where the said cylindrical chamber (43) fits inside the said central channel (13a) which it seals with the said pedestal (48), and where the intake of the mixture to the said cylindrical chamber (43) and the following even distribution by means of the holes (35b) and ports (35b′) to the cylinders (2) is performed when rotation of the said central axis (3) brings the said port opening (44) of the cylindrical chamber (43) to coincide with the said hole on the perimeter of the central channel (13a).

4. A multi-cylinder two-stroke radial internal combustion engine according to claim 1, characterized by the fact that each of the said crankshafts (8a) is jointly manufactured, of one single piece of metal as the gear wheel (8b) which it bears at one of its ends and the overlying to the gear wheel (8b) eccentric surface with pin (8c) connecting to an end ring (6a) of the said connecting rod (6) and that at the other end each of the said crankshafts (8a) has a slit (8d) inside which it is locked by a safety lock after passing through the cylindrical body (1).

5. The multi-cylinder two-stroke radial internal combustion engine according to claim 1 is used in scale models and especially models with a cubature in the order of 0.30-1.20 in³, as well as in models intended for aircraft model applications due to its characteristic resemblance to early-era engine configurations.
